(19) United States
(12) Patent Application Publication
(10) Pub. No.: US 2016/0298202 A1
(43) Pub. Date: Oct. 13, 2016

(54) INTERSCALAR INTEGUMENT POSITION SETTING METHOD AND MANUFACTURE

(71) Applicant: Eden Bio-Creations, LLC, Kansas City, MO (US)

(72) Inventor: Mark Tovar, Kansas City, MO (US)

(21) Appl. No.: 15/094,581

(22) Filed: Apr. 8, 2016

Related U.S. Application Data
(60) Provisional application No. 62/145,272, filed on Apr. 9, 2015.

(51) Int. Cl. C14B 7/00

(52) U.S. Cl. CPC C14B 7/00

(57) ABSTRACT

A method is disclosed for setting the interscalar integument of a reptile shed for incorporation into a laminar composite. The method includes saturating the reptile shed in a saturating liquid, positioning the saturated reptile shed on a lower platen of a press, lowering an upper platen of the press to contact the saturated reptile shed, flash drying the saturated reptile shed by simultaneously applying heat and pressure using the upper and lower platens for a fixed period of time.

### CROSS-REFERENCE TO RELATED APPLICATIONS AND PRIORITY CLAIM

This application claims priority to U.S. Provisional Patent Application No. 62/145,272, filed Apr. 9, 2015 and entitled “Interscalar Integument Position Setting.”

### FIELD

The disclosure relates generally to the field of composite materials. More specifically, the disclosure relates to the field of laminar composites which incorporate reptile shed.

### BACKGROUND

The trade in reptile skins, especially snake skins, for fashion items such as shoes, belts, and handbags is a very large industry. For example, the trade in South-East Asian python skins alone is estimated by the International Trade Center (an agency of the U.N. and W.T.O.) to be a U.S. $1 billion dollar industry, consuming over 470,000 python skins per year. Kasterine, A., et al., The Trade in South-East Asian Python Skins. INTERNATIONAL TRADE CENTRE (ITC), 2012, incorporated here by reference. Harvesting these skins kills the snakes, resulting in great environmental damage and unnecessary cost.

Both the environmental damage and cost could be avoided by using a renewable resource to produce a similarly desirable product to leather made from whole reptile skins. Reptile shed, particularly snake shed, provides such a renewable resource. Snake shed can be used to produce a realistic-looking laminar composite which can be used for the same products as leather made from whole snake skins. See U.S. patent application Ser. No. 13/480,330, incorporated herein by reference.

### SUMMARY

In order to provide the most aesthetic and realistic appearance, the scales of the shed may need to be manipulated and set into position before the snake shed is used to produce a realistic-looking laminar composite. A method is disclosed for setting the interscalar integument of a reptile shed for incorporation into a laminar composite. The method includes saturating the reptile shed in a saturating liquid, positioning the saturated reptile shed on a lower platen of a press, lowering an upper platen of the press to contact the saturated reptile shed, flash drying the saturated reptile shed by simultaneously applying heat and pressure using the upper and lower platens for a fixed period of time.

In another embodiment the method further includes washing the reptile shed in a washing liquid. In one embodiment, the washing liquid includes at least fifty percent water by volume. In another embodiment, washing liquid further includes a surfactant. In another embodiment, the washing liquid further includes up to fifty percent alcohol by volume.

In another embodiment, the method further includes manually manipulating the scales of the reptile shed prior to flash drying. In another embodiment, the method further includes removing bubbles from the reptile shed by applying pressure with a linearly edged tool while simultaneously drawing the linearly edged tool from an interior portion of the reptile shed to an edge of the reptile shed.

In another embodiment, the saturating liquid includes water. In another embodiment, the water in the saturating liquid is deionized water. In another embodiment, the saturating liquid is pure water.

In another embodiment, the lower platen is covered with a polymer. In another embodiment, that polymer is polytetrapolyethylene.

In another embodiment, the method further includes covering the saturated reptile shed with a polymer before lowering the upper platen. In another embodiment, the covering polymer is polytetrapolyethylene. In another embodiment, the upper platen is covered with polytetrapolyethylene.

In one embodiment, the fixed period of time is between 6 and 22 seconds and the platen temperature is between 212° F. and 400° F. In another embodiment, the fixed period of time is between 12 and 20 seconds and the platen temperature is between 275° F. and 335° F. In another embodiment the press applies between 60 and 120 pounds of force to the platens. In another embodiment the press applies between 70 and 90 pounds of force to the platens.

### BRIEF DESCRIPTION OF THE DRAWINGS

FIG. 1 is a flow chart of one embodiment of the method 100 used to set the interscalar integument of a reptile shed, particularly snake shed, in accordance with the present disclosure.

FIG. 2 is an illustration of a representative heat press which may be used with the disclosed method and a saturated snake shed positioned for flash drying, in accordance with the present disclosure.

### DETAILED DESCRIPTION

In biology, integument is the natural covering of an organism such as its skin or shell. The integument of reptiles, particularly snakes, is composed of two main types: scales and interscalar integument (skin), both of which originate from the epidermis. Scales are relatively inelastic while the interscalar integument is thin and highly elastic. Snakes shed their skin as a necessary biological process, referred to as “ecdysis.” Snake shed is the natural byproduct of this process and includes the outermost keratinized integument which is shed in one continuous layer. The shedding process takes place in healthy snakes and is in stark contrast to the practice of skinning a snake for its hide, which kills the snake. The hide from a killed snake is much like leather whereas snake shed is a thin and fragile keratinized integument of a living snake.

Embodiments of the present invention relate to purposefully setting the position of interscalar integument located between the scales of a snake shed. In at least some embodiments, an optimal distance between the scales is set to lock into place the most visually aesthetic and realistic orientation of the integument as a whole.

Embodiments of the present invention provide a dried, sanitized snake shed in which the distance of the interscalar integument is purposefully controlled. The flash drying process, completed with a heat press, is done prior to preserving the snake shed and gives the snake shed a more realistic look. In particular, the disclosed process has been found to restrict the natural shrinkage of the interscalar integument while sanitizing and flash drying said snake shed.

The method of the disclosure provides a snake shed where the interscalar integument is positioned into a desired placement prior to a fast, high-heat press, which locks the desired position of the interscalar integument in place. The disclosed method flash-dries the water and/or alcohol saturated snake shed which renders the snake shed ready for use in a preservation process.

While going through the process of setting the position of the interscalar integument and locking it in place, it has been found that setting the high heat of the press at over 300 degrees Fahrenheit sanitizes the snake shed. For at least some aspects of the invention, it is desirable to sanitize the snake shed in this manner because the snake shed is biological material and may have come into contact with feces or other contaminant.

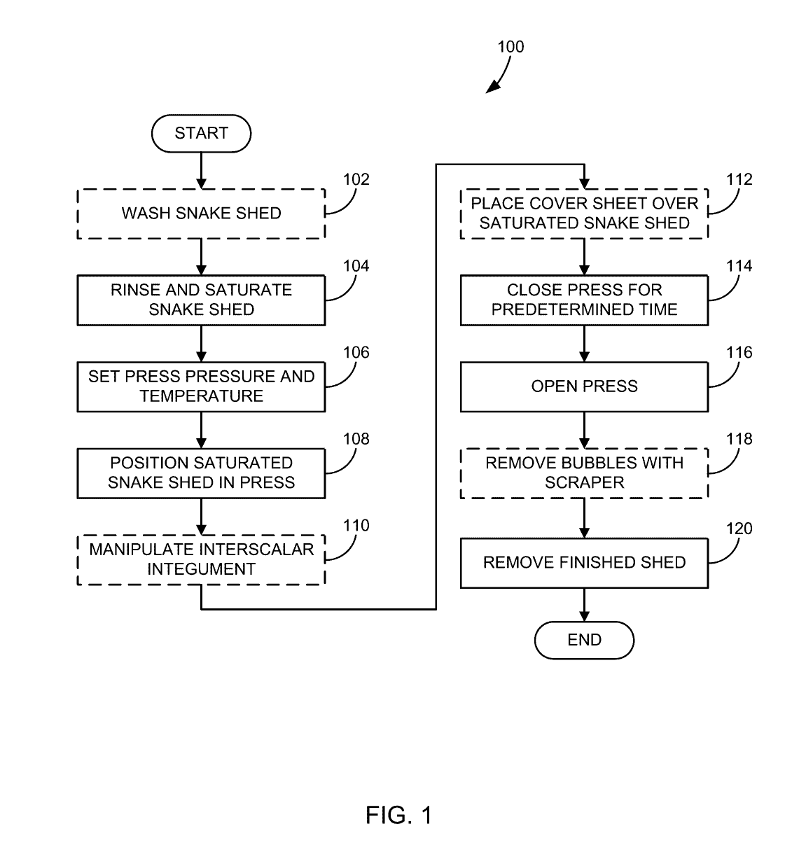

Referring now to the Figures, in which like reference numerals represent like parts, various embodiments of the method and the resulting snake shed will be disclosed in detail. FIG. 1 is a flow chart of one embodiment of the method 100 used to set the interscalar integument of a reptile shed, particularly snake shed. At 102, the snake shed is placed in a room-temperature washing solution. In some embodiments, the washing solution may be soapy water. In other embodiments, for example if the shed will not separate with just soapy water, the washing solution may be a water/alcohol mixture. In some embodiments, the water/alcohol may contain up to 50% alcohol by volume. A variety of alcohols may be used. For example, and without limitation, ethanol, methanol, and isopropanol may be used. The washing solution with the snake shed is then agitated with a stirring rod, to wash away foreign particles or contaminants. The wash also aids in separating the snake shed if it has become stuck to itself.

At 104, the shed is placed in a rinsing solution. In one embodiment, the rinsing solution is clean room-temperature water. In another embodiment, the rinsing solution may contain up to 50% alcohol by volume. A variety of alcohols may be used. For example, and without limitation, ethanol, methanol, and isopropanol may be used. This cleaning and rinsing process produces a saturated snake shed that is pliable and suitable for the manipulation of spacing between the scales which is referred to as interscalar integument setting when it is pressed through the flash drying process.

The interscalar integument is set using a flash drying process. In some embodiments, the flash drying process is performed in a heat press. At 106, the parameters for the heat press are set. The parameters are set forth in more detail below. At 108, the snake shed is placed on the lower platen of the heat press. In some embodiments, the lower platen of the press may be covered with a cover sheet. In some further embodiments, the cover sheet may be polymeric. In further embodiments, the polymeric cover sheet may be a tetraflouroethylene (TFE) polymer. In further embodiments, the tetraflouroethylene (TFE) polymer may be polytetraflouroethylene (PTFE).

At 110, in some embodiments of the method the pliable shed (i.e., integument) may be manually manipulated by the operator. Specifically, when saturated, the parts of the integument between the scales (i.e., the interscalar integument) is particularly pliable and elastic and permits the scales of the snake shed to be moved relative to each other. Parts of the interscalar integument can be selectively stretched to position the scales of the snake shed. Such stretching of the interscalar integument may involve elastic deformation and/or plastic deformation of the interscalar integument. For instance, the elastic interscalar integument permits an operator to manually move scales closer to one another or away from one another to produce a preferred integument arrangement. Such elastic manipulation of the integument is preferably done prior to flash drying the integument.

At 112, with the integument positioned as desired on the lower platen, a cover sheet is placed on top of the snake shed. In some further embodiments, the cover sheet may be polymeric. In further embodiments, the polymeric cover sheet may be a tetraflouroethylene (TFE) polymer. In further embodiments, the tetraflouroethylene (TFE) polymer may be polytetraflouroethylene (PTFE).

At 114, the press is closed and the snake shed is compressed and heated by the heat press in a single heating cycle. During the preferred heating cycle, the heating temperature ranges from about 212° F. to about 400° F. and, more preferably, about 305° F. The heating cycle to heat the shed preferably includes a continuous heating time that ranges from about 6 seconds to about 20 seconds and, more preferably, from about 12 seconds to about 20 seconds. The cycle time will depend on temperature used and amount of water the snake shed has retained from the washing and rinsing.

The heating cycle also includes a pressure setting for the heat press that determines the amount of pressure applied by the platens to the shed. In the example heat press (discussed at greater length below) the pressure is applied by a factory-calibrated over-center cam within the mechanism of the press. The force applied by the press is adjusted between non-dimensional settings from 0-10. A setting of 0 indicates no pressure. A setting of 10 applies approximately 100 lbs of force. During flash drying, the pressure setting preferably ranges from about 6 to about 10 and, more preferably is about 8. These pressure settings roughly correspond to between 60 and 100 pounds force, and preferably 80 pounds of force. It has been found that these preferred settings associated with the heating cycle serve to lock the interscalar integument into the desired position as well as flash drying and sanitizing the snake shed.

At 116, the press is opened. At 118, in some embodiments of the method the operator can run a scraping device over the top of the cover sheet to remove any air bubbles located within the integument. At 120, the operator can then remove the cover sheet and the snake shed from the lower platen.

In other embodiments, a person may place any biological materials, such as leaves, flowers, or insect parts through this flash drying process. Although some biological materials, for example leaves, do not become pliable after saturation, the flash drying process is still important in order to remove moisture that is naturally in the biological material. Due to the water content in a flower, it is helpful to place a sheet of paper under the flower on the lower platen prior to pressing it with the heat press. Other than placing a sheet of paper under the flowers, all biological materials can be flash dried in the same way as the snake shed.

Once the interscalar integument is set through this process, which also flash dries the snake shed, or any biological material such as leaves, flowers, bug and insect parts, the resulting product can then be used as a layer in a laminar composite preservation product.

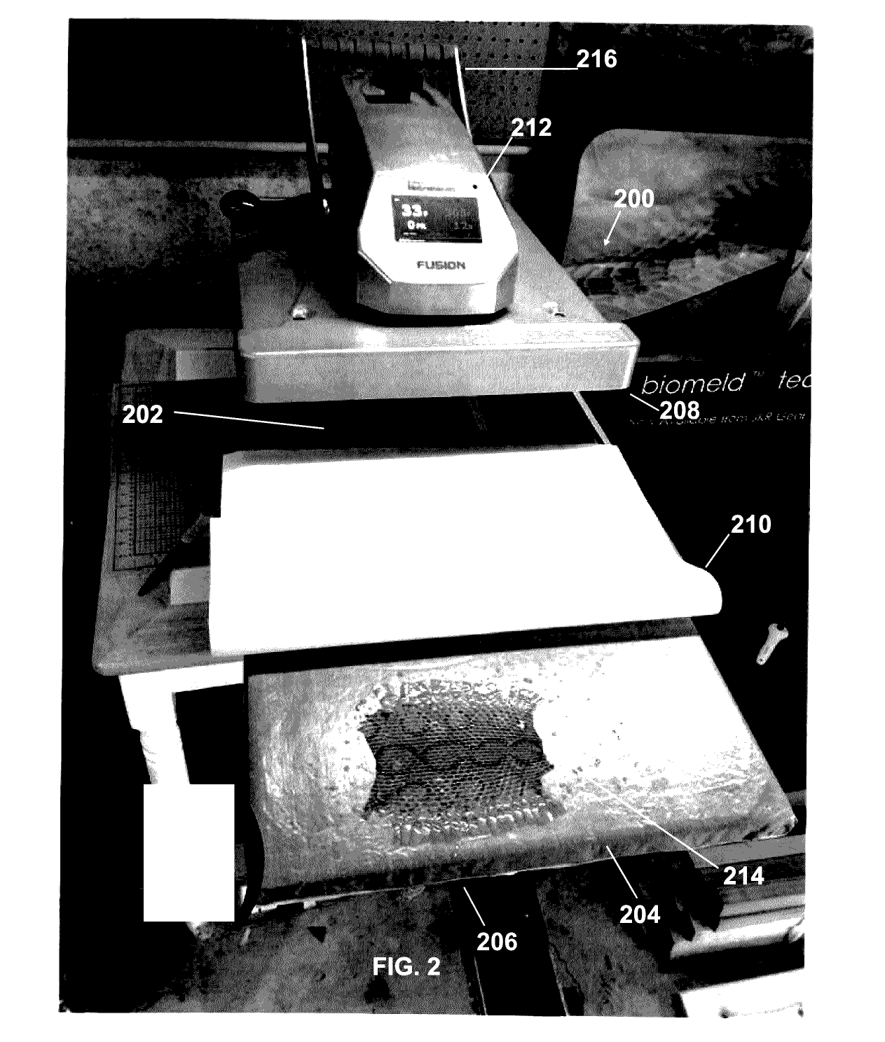

The saturated snake shed is preferably flash dried using a powered heat press. FIG. 2 is an illustration of a representative heat press 200 with a saturated snake shed 214 positioned for flash drying, which may be used with the disclosed method. The illustrated heat press is preferably a Fusion® heat press, manufactured by Hotronix® of Carmichaels, Pa. However, it is within the scope of the present invention that an alternative heat press is used for flash drying of snake shed or other biological material. For some aspects of the present invention, a heating device other than a heat press (such as a heating iron) could be used to provide flash drying of snake shed or another biological material.

The press 200 includes a base 202, a lower platen 204, a lower platen fitted cover sheet 206, an upper heated platen 208, an upper cover sheet 210, and a user interface 212. The cover sheets 206, 210 are preferably made from PTFE, although other materials such as other polymers may be suitable. The lower cover sheet 206 is fitted closely to and covers the rest of the lower platen 204. The upper heated platen 208 is shiftable into and out of engagement with the lower platen 204 to heat material positioned between the platens.

In FIG. 2, the lower platen 204 is shifted to a laterally extended position and the upper platen 208 is in an upper disengaged position. To begin heating, the lower platen 204 is then moved to a retracted position below the upper platen 208. With the lower platen 204 retracted, an engagement lever 216 can be swung forwardly to move the upper platen 208 from the upper disengaged position to a lower engaged position. The lower engaged position engages the upper cover sheet 210 so that the upper cover sheet 210 and lower cover sheet 206 engage the snake shed 214 there between.

With completion of the heating cycle, the upper platen 208 is returned to the disengaged position and the lower platen 204 is extended to provide access to the upper cover sheet 210 and the snake shed 214.

To facilitate an understanding of the principals and features of the disclosed technology, illustrative embodiments are explained above. The components described hereinafter as making up various elements of the disclosed technology are intended to be illustrative and not restrictive. Many suitable components that would perform the same or similar functions as components described herein are intended to be embraced within the scope of the disclosed methods. Such other components not described herein may include, but are not limited to, for example, components developed after development of the disclosed technology.

It must also be noted that, as used in the specification and the appended claims, the singular forms “a,” “an” and “the” include plural referents unless the context clearly dictates otherwise.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The design and functionality described in this application is intended to be exemplary in nature and is not intended to limit the instant disclosure in any way. Those having ordinary skill in the art will appreciate that the teachings of the disclosure may be implemented in a variety of suitable forms, including those forms disclosed herein and additional forms known to those having ordinary skill in the art

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method for setting the interscalar integument of a reptile shed for incorporation into a laminar composite, the method comprising:
saturating the reptile shed in a saturating liquid;
positioning the saturated reptile shed on a lower platen of a press;
lowering an upper platen of the press to contact the saturated reptile shed;
flash drying the saturated reptile shed by simultaneously applying heat and pressure using the upper and lower platens for a fixed period of time.

2. The method of claim 1 further comprising the step of washing the reptile shed in a washing liquid.

3. The method of claim 2 where the washing liquid comprises at least fifty percent water by volume.

4. The method of claim 3 where the washing liquid further comprises a surfactant.

5. The method of claim 3 where the washing liquid further comprises up to fifty percent alcohol by volume.

6. The method of claim 1 further comprising manually manipulating the scales of the reptile shed prior to flash drying.

7. The method of claim 1 further comprising removing bubbles from the reptile shed by applying pressure with a linear edge of a tool while simultaneously drawing the linear edge of the tool from an interior portion of the reptile shed to an edge of the reptile shed.

8. The method of claim 1 where the saturating liquid comprises water.

9. The method of claim 8 where the water comprising the saturating liquid is deionized water.

10. The method of claim 1 where the saturating liquid consists of water.

11. The method of claim 1 where the lower platen is covered with a polymer.

12. The method of claim 11 where the polymer is polytetrapolyethylene.

13. The method of claim 1 further comprising covering the saturated reptile shed with a polymer before lowering the upper platen.

14. The method of claim 13 where the polymer is polytetrapolyethylene.

15. The method of claim 1 where the upper platen is covered with polytetrapolyethylene.

16. The method of claim 1 where the fixed period of time is between 6 and 22 seconds and the platen temperature is between 212° F. and 400° F.

17. The method of claim 16 where the fixed period of time is between 12 and 20 seconds and the platen temperature is between 275° F. and 335° F.

18. The method of claim 1 where during flash drying the press applies between 60 and 120 pounds of force to the platens.

19. The method of claim 18 where during flash drying the press applies between 70 and 90 pounds of force to the platens.

20. A reptile shed for incorporation into a laminar composite manufactured by the method of claim 1.
